(19) United States
(12) Patent Application Publication
(10) Pub. No.: US 2024/0103626 A1
(43) Pub. Date: Mar. 28, 2024

(54) HAPTIC RING

(71) Applicant: Meta Platforms Technologies, LLC, Menlo Park, CA (US)

(72) Inventors: Dan Kun-yi Chen, Seattle, WA (US); Chengyuan Yan, San Bruno, CA (US)

(21) Appl. No.: 18/470,825

(22) Filed: Sep. 20, 2023

Related U.S. Application Data
(60) Provisional application No. 63/376,879, filed on Sep. 23, 2022.

(51) Int. Cl. G06F 3/01; G06F 3/0354

(52) U.S. Cl. CPC G06F 3/016; G06F 3/03547; G06F 1/163

(57) ABSTRACT

The disclosed apparatus may include a wearable haptic ring that features input capabilities relative to a computing system. In various examples, the wearable haptic ring may be designed to curve around a human finger of a wearer with a touchpad that is seamlessly integrated with the ring. For example, the seamlessly integrated touchpad may be operable by another finger of the wearer. Moreover, the haptic ring may include a haptic feedback unit designed to provide haptic feedback in response to input from the wearer. As such, the haptic ring may enable a wide range of user inputs while appearing like a typical ring rather than a computer input/output device. Various other implementations are also disclosed.

### CROSS REFERENCE TO RELATED APPLICATION

This application claims the benefit of U.S. Provisional Application No. 63/376,879, filed 23 Sep. 2022, the disclosures of which is incorporated, in its entirety, by this reference.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1A illustrates an example haptic ring including a seamlessly integrated touchpad in accordance with one or more implementations.

FIG. 1B illustrates the example haptic ring of FIG. 1A on a user's finger in accordance with one or more implementations.

FIG. 2A illustrates another example haptic ring in accordance with one or more implementations.

FIG. 2B illustrates the example haptic ring of FIG. 2A on a user's finger in accordance with one or more implementations.

FIG. 3 illustrates another example haptic ring in accordance with one or more implementations.

FIG. 4 illustrates a diagram of a haptic ring electronically communicating with a computing device in accordance with one or more implementations.

FIG. 5 is an illustration of example augmented-reality glasses that may be used in connection with embodiments of this disclosure.

FIG. 6 is an illustration of an example virtual-reality headset that may be used in connection with embodiments of this disclosure.

FIG. 7 is an illustration of example haptic devices that may be used in connection with embodiments of this disclosure.

FIG. 8 is an illustration of an example virtual-reality environment according to embodiments of this disclosure.

FIG. 9 is an illustration of an example augmented-reality environment according to embodiments of this disclosure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY IMPLEMENTATIONS

There are many input devices for interacting with computational systems. For example, users may interact with keyboards, mice, touch screens, track pads, joysticks, etc. when inputting information into a computing device. More sophisticated systems may even include microphones for voice inputs, gyroscopes and magnetometers for gesture-based inputs, or even cameras for no-contact user inputs.

Despite this, existing input mechanisms may not be desirable for use in connection with certain types of computing systems. To illustrate, some systems—such as augmented reality (AR) or virtual reality (VR) systems—include wearable, near-eye displays that can only be seen by the wearer. Moreover, some systems include wearable, near-eye displays that are not fully opaque, such as with wearable AR glasses. Because of this, users may interact with these systems while walking, eating in a restaurant, sitting in a park, in the company of other people, or in other public places. As such, it may be problematic for such users to carry additional input devices (e.g., such as a mouse or keyboard) while interacting with an AR or VR system. Moreover, such users may find it cumbersome or awkward to make large or noticeable gestures to interact with systems (e.g., as with an “air mouse” or similar).

Thus, the present disclosure describes a wearable haptic ring that includes input capabilities relative to a computing system. In various examples, the wearable haptic ring may be an apparatus including a ring designed to curve around a human finger of a wearer, a touchpad integrated with the ring and operable by another finger of the wearer, and a haptic feedback unit integrated with the apparatus and designed to provide haptic feedback in response to input from the wearer. The touchpad may curve in a manner that substantially follows the curving of the ring around the human finger. Moreover, the touchpad may be seamlessly integrated into the ring such that the ring appears like a typical ring rather than a computer input/output device.

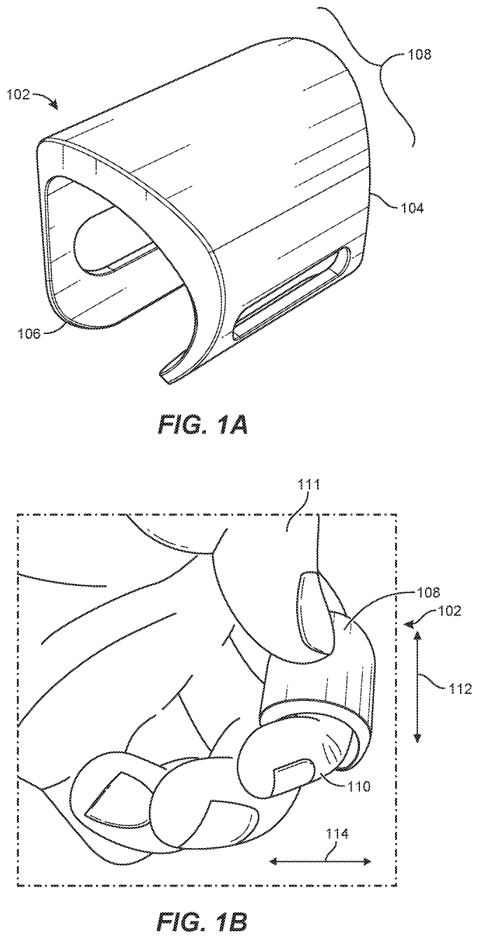

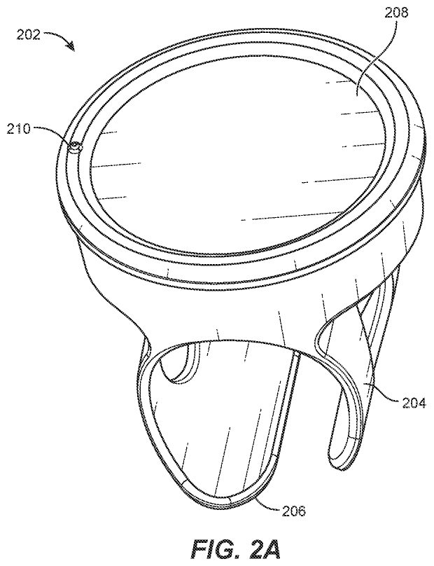

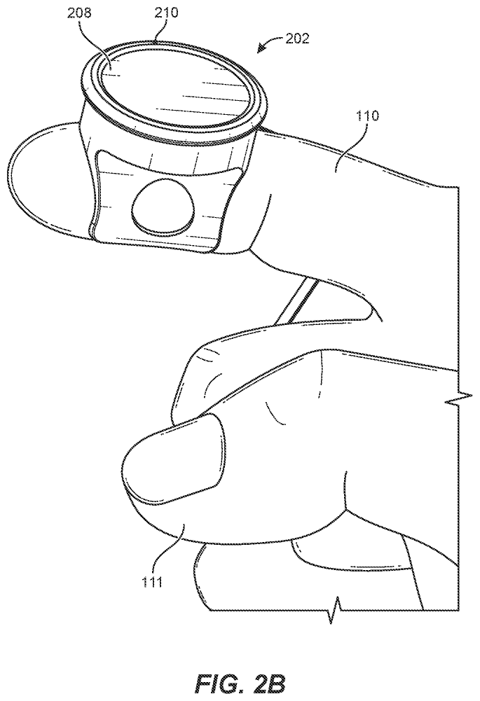

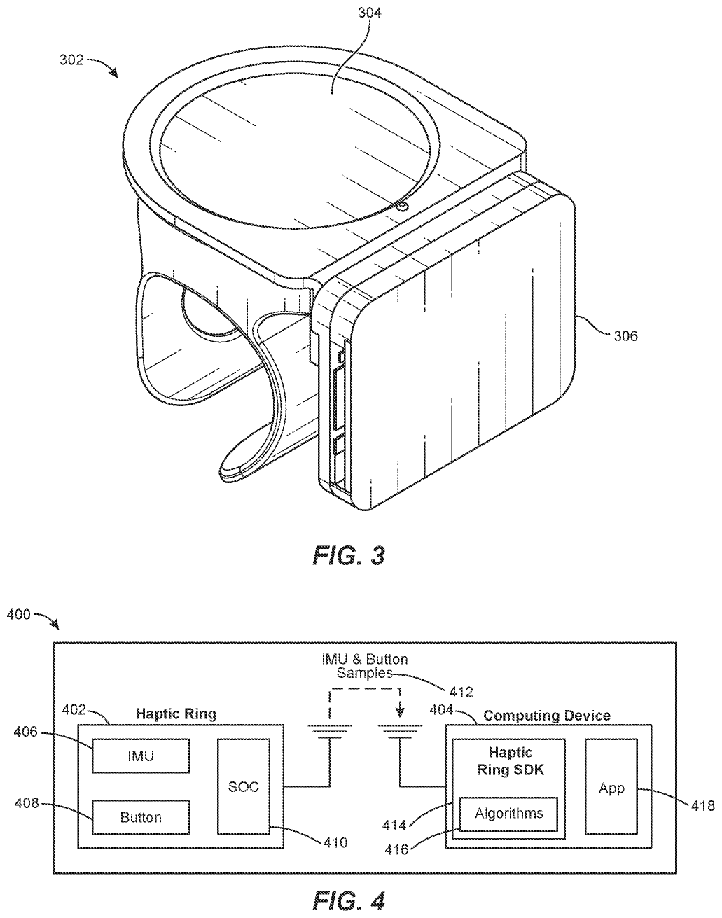

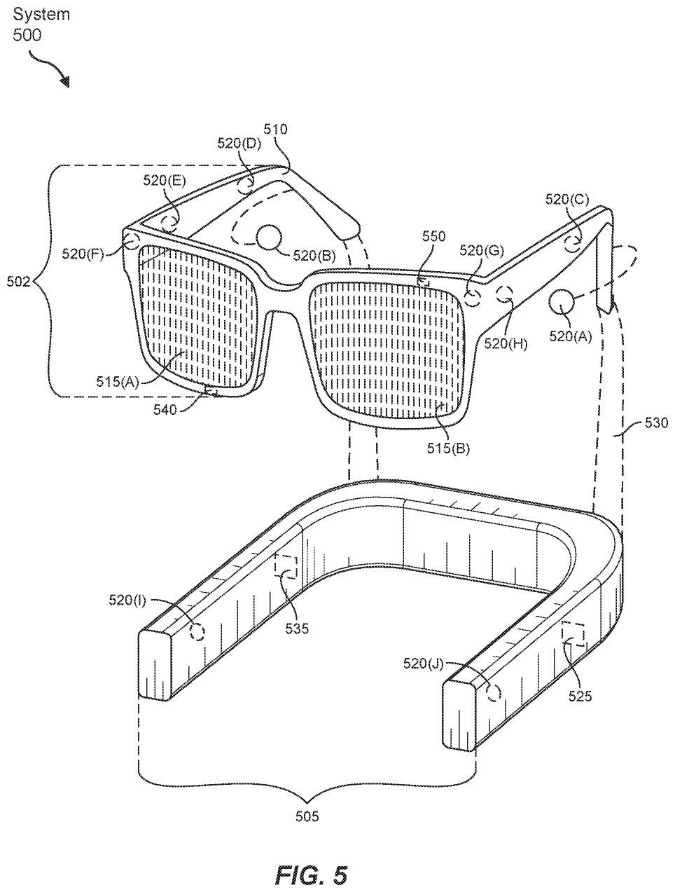

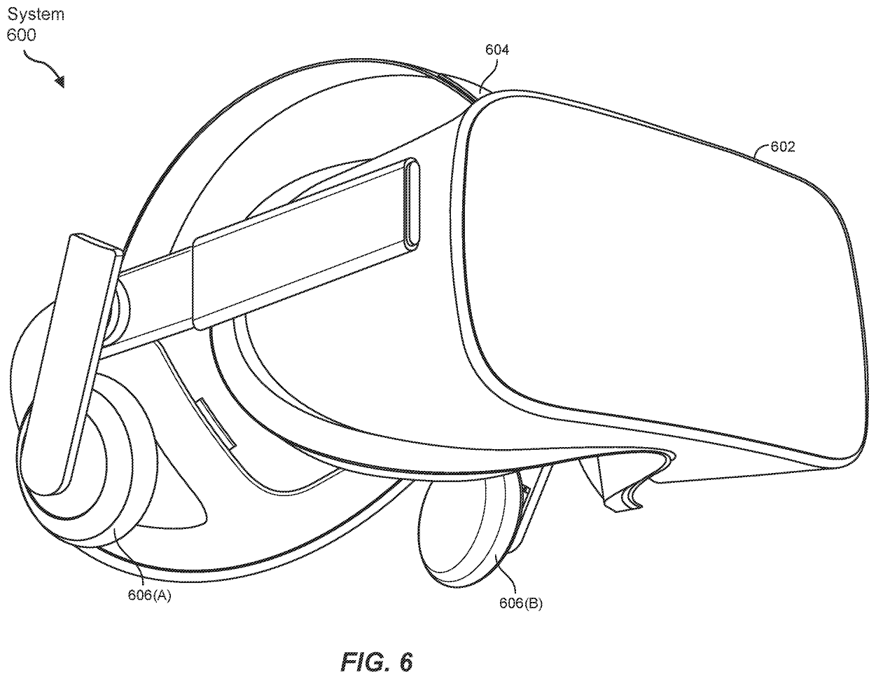

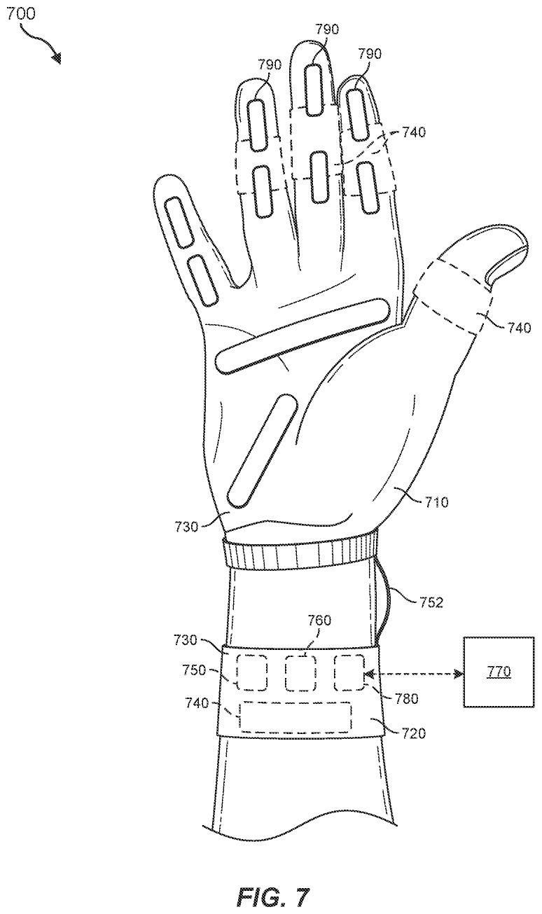

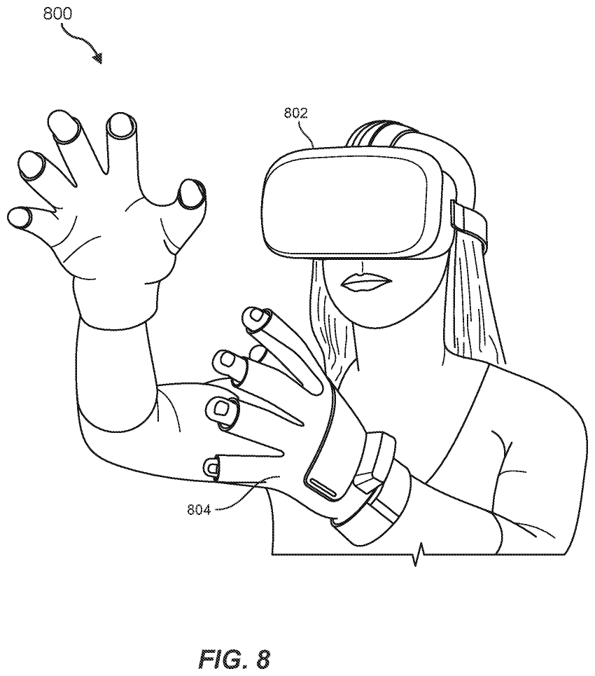

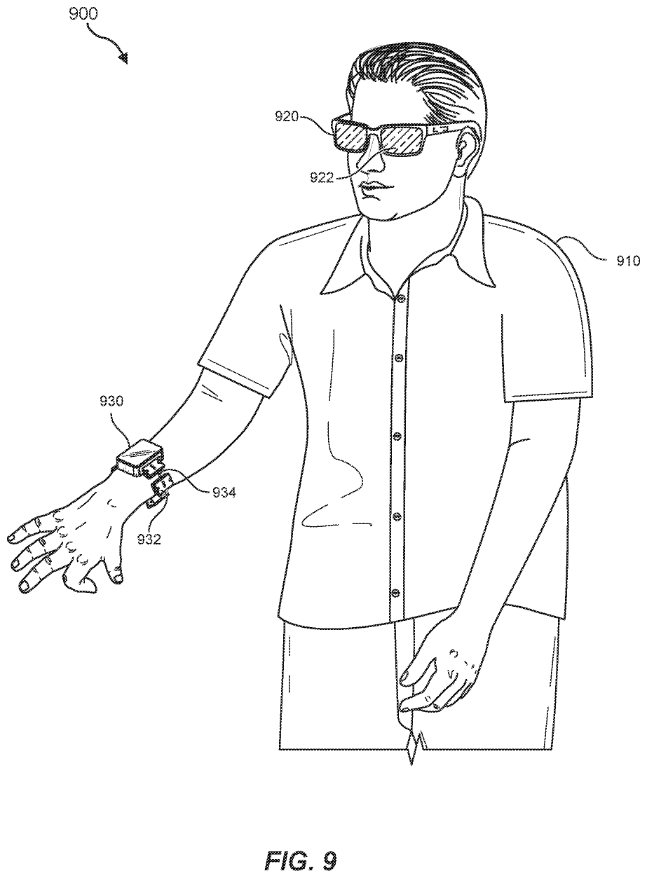

The following will provide, with reference to the FIGS. 1A-9, detailed descriptions of a haptic ring. For example, FIGS. 1A and 1B illustrate an example haptic ring featuring a seamlessly integrated touchpad along with a haptic feedback unit, inertial measurement unit, and more. FIGS. 2A and 2B illustrate another example haptic ring with a circular touchpad. FIG. 3 illustrates another example haptic ring with a circular touchpad and additional pressure-sensing touchpad. FIG. 4 illustrates a diagram of a haptic ring electronically communicating with a computing device to transmit inertial measurement unit data and other haptic ring data. FIG. 5 illustrates example augmented-reality glasses while FIG. 6 illustrates an example virtual-reality headset. FIG. 7 illustrates example haptic devices and FIG. 8 illustrates an example virtual-reality environment. Finally, FIG. 9 illustrates an example augmented-reality environment.

As just mentioned, the present disclosure describes multiple implementations of a wearable haptic ring that serves as an input device for a computing system. In one implementation, as shown in FIG. 1A, a haptic ring 102 including a touchpad 108 that is integrated (e.g., seamlessly integrated) into a ring portion 104 of the haptic ring 102. The ring portion 104 may be closed or partially open at a base 106, as further shown in FIG. 1A. In this example, the touchpad 108 may be seamlessly integrated into the ring portion 104 such that the user is effectively presented with a single, streamlined, and/or uniform surface.

As such, an exact perimeter of the touchpad 108 may not be visible to the human eye. Instead, the natural orientation of the haptic ring 102 on the wearing finger (e.g., placing an opening of the ring portion ring portion 104 away from the thumb and an opposite surface indicating the touchpad 108 adjacent the thumb) may implicitly indicate to the user the effective location of the touchpad 108 such that the user can intuit how to gesture along the seamlessly integrated touchpad 108 to provide input.

To demonstrate, FIG. 1B shows the haptic ring 102 on an index finger 110 of a user. In one or more implementations, the haptic ring 102 may be worn on the index finger 110 of the user in an orientation such that the touchpad 108 is directed toward a thumb 111 of the user. In this implementation, the orientation of the haptic ring 102 may implicitly indicate that touch gestures on the touchpad 108 in a first direction (e.g., along the arrow 112) are along an x-axis, while touch gestures on the touchpad 108 in a second direction (e.g., along the arrow 114) are along a y-axis. This implicit orientation can reduce the time and computational resource expenditure common to how the user learns to interact with the haptic ring 102.

In more detail, the curved nature of the surface of the touchpad 108 may provide a natural affordance for an x-axis or axis that is horizontal from the perspective of the user. In other words, the curved nature of the touchpad 108 effectively bends a two-dimensional touchpad around one dimension (e.g., the Y dimension) as the touchpad 108 curves around the finger of the user (i.e., from one side of the finger to an opposite side of the finger, the outside of the finger bends around a curve). On the other hand, the same finger of the user does not bend along another dimension (i.e., from a first knuckle of the finger to a second knuckle of the finger). This latter dimension effectively corresponds to the axis of the finger, which is substantially straight (e.g., is substantially straight when the user straightens his or her finger). The effective straightness of this dimension of the finger (e.g., along the arrow 112) provides a natural and intuitive axis (e.g., x-axis) that the user can intuitively understand. In other words, by feeling along the curving two-dimensional surface, which curves only in one of the two relevant dimensions, but substantially does not curve in the other of the two relevant dimensions, the user may detect the dimension along which the surface is not curving and intuitively understand that this dimension corresponds to a specific dimension within an application. Generally speaking, the axis corresponding to the straight dimension of the touchpad 108 (e.g., along the arrow 112) may correspond to an x axis or horizontal dimension within a corresponding display (e.g., screen, virtual-reality display, augmented reality display, smart glasses, etc.), while the curved dimension of the touchpad 108 (e.g., along the arrow 114) may correspond to a y-axis. Alternatively, in other examples a different dimension may be used, although this may be less intuitive to the user.

In some examples, the touchpad 108 is implemented on a flexible printed circuit board such that the printed circuit board flexes around the curving of the haptic ring 102. For example, the flexible printed circuit board can include a thin, flexible substrate with conductive traces. In further examples, the flexible printed circuit board may be flexible to the point that it can be bent, folded or even creased. One example of such a flexible printed circuit is one that is disposed on a super-flex material. Additionally, in some examples, a haptic feedback unit is disposed beneath the flexible printed circuit board within the haptic ring 102 (e.g., layered underneath the touchpad 108). In such examples, a driver and/or an inertial measurement unit (IMU) can be further disposed beneath the flexible printed circuit board. The flexible printed circuit board can be two-sided or four-sided. Moreover, the haptic ring 102 may further include a wireless communication component (e.g., a Bluetooth® component such as nRF53) and a battery component beneath the IMU. As used herein, the term “beneath” may indicate that a unit (e.g., the haptic feedback unit) is disposed closer to the finger than the flexible printed circuit board, etc.

The haptic ring 102 may also have one or more of the following optional properties. In further examples, a thickness of the haptic ring 102 may be selected to optimize a corresponding curvature. In some examples, the flexible printed circuit board may be disposed between an upper and a bottom portion of flexible material, such that the flexible printed circuit board is embedded within and/or protected by such material. In various examples, a finger rejection algorithm may be implemented (e.g., through machine learning or otherwise) to reject unintended or undesired input on the corresponding touchpad (e.g., to reject any input by a finger other than the input finger generally corresponding to the thumb 111, including rejecting input by the finger wearing the ring or any remaining finger). Additionally, or alternatively, a larger touchpad using a lower resolution or a smaller touchpad using a higher resolution may be used to prevent detection or recognition of undesired input. As used herein, undesired, rejected, or inappropriate input may refer to input that is rejected according to game, system, or design specifications when considering the operation of the haptic ring 102 within a larger gaming or software application environment.

As mentioned, in some examples, the haptic ring 102 may include an IMU (inertial measurement unit), such as a magnetometer. In at least one implementation, the IMU may provide nine degrees of freedom. Moreover, in an implementation that includes a magnetometer, the haptic ring 102 can further include a shield that prevents the magnetometer from interfering with other components within the haptic ring 102. For example, the shield can shield the magnetometer from reading an item of data from one or more additional components within the haptic ring 102.

Additional implementations of the haptic ring may include a touchpad in a different configuration. For example, as shown in FIG. 2A, an example haptic ring 202 may include a circular touchpad 208 that is substantially flat. The haptic ring 202 may further include a ring portion 204 that is designed to substantially curve along a human finger that is wearing the ring. The ring portion may be closed or partially open at a base 206, as further shown in FIG. 2A.

Additionally, the haptic ring 202 may include an IMU (initial measurement unit), which may provide nine degrees of freedom. The haptic ring 202 may also include an indicator 210 at the top, which may indicate a portion (e.g., a top) of the haptic ring 202 facing away from the user when wearing the haptic ring 202. In some examples, the ring portion of the haptic ring 202 may be opened such that the ring fits a wider range of individuals, and may be easier to attach or detach or otherwise move around a finger such as the index finger. Moreover, the haptic ring 202 may include an embedded haptic feedback unit, such as a linear resonant actuator (LRA) haptic feedback unit, positioned beneath the circular touchpad 208. In some examples, the haptic ring 202 may further include a battery, which may be curved and embedded such that a curving of the battery is at least partially consistent with the curving of the haptic ring 202.

As shown in FIG. 2B, the haptic ring 202 may be worn on the index finger 110 of the user with the indicator 210 positioned at the top of the circular touchpad 208. In this position, the user may use their thumb 111 to interact with the circular touchpad 208 of the haptic ring 202. Unlike the haptic ring 102 illustrated in FIGS. 1A and 1B, the circular touchpad 208 of the haptic ring 202 is substantially flat. As such, the user may not inherently understand the directionality of the haptic ring 202 because the surface of the circular touchpad 208 is uniform and uncurved.

FIG. 3 illustrates another implementation of the haptic ring. For example, FIG. 3 shows a haptic ring 302 including a circular touchpad 304 as well as a pressure sensing touchpad 306. In this implementation, the haptic ring 302 may provide absolute orientation, a rotation vector, and/or an initial measurement unit integration, and so forth. Additionally, the pressure sensing touchpad 306 of the haptic ring 302 may also provide high precision pressure sensing, which may be implemented according to an optical configuration. In some examples, the pressure sensing touchpad 306 of the haptic ring 302 may combine capacitance tap data with pressure sensing, which may enable a force touch embodiment. To illustrate, the haptic ring 302 may act as an “air mouse” such that a user may interact with the circular touchpad 304 to move a cursor around within a display. The user may then interact with the pressure sensing touchpad 306 to “click on” a displayed item.

Regardless of the implementation, the haptic ring (e.g., either the haptic ring 102, the haptic ring 202, or the haptic ring 302) can be operated in multiple ways. For example, in one implementation, the haptic ring may enable swiping in any one or more of four different directions. To demonstrate, an input finger such (e.g., such as the thumb 111) may begin on the left-hand side of the touchpad (e.g., either the touchpad 108, the circular touchpad 304, or the circular touchpad 208) and then swipe rightward. In response, a graphical user interface may effectively scroll in a corresponding right-hand, horizontal, or otherwise parallel direction (e.g., seamlessly scroll across a horizontal series of album covers). Similar functionality may be implemented by the user pressing (e.g., long pressing or pressing for a predetermined amount of time) at one or more of the edges of the touchpad (e.g., the rightward edge) to effectively navigate in a parallel or corresponding direction. The long pressing embodiment may involve less finger movement than in the swiping embodiment. Additionally, in the long pressing embodiment, the user may have the option to see and/or correct the selection due to the fact that a delayed activation time is implemented (e.g., as the user begins a long press in one direction, the user may have the opportunity to evaluate whether the input is correct or the direction is correct, prior to the delayed activation time being triggered, such that the user may abort the long press prior to the delayed activation time being triggered).

In one or more implementations, the haptic ring may enable stateful input (e.g., track tap or hover and lifted input) and/or stateless input (e.g., a swipe direction input). To demonstrate, a play/pause command may be implemented through a corresponding tap input. Selecting a next or previous song may be implemented through swiping in a corresponding direction and/or hovering over a corresponding edge. Similarly, selecting an increase or decrease in volume may be implemented through swiping in a corresponding direction and/or hovering over a corresponding edge. These examples are merely illustrative and, in other examples, these commands or similar commands may be mapped to input procedures in any suitable permutation, as understood by those having skill in the art.

In another example, the haptic ring may enable multi-directional swipe inputs. For example, a wearer of the haptic ring may draw a human language character (e.g., an English or Chinese character) using the touchpad. Similarly, the user may twist or rotate the wrist of the hand wearing the ring clockwise (e.g., right) or counter-clockwise (e.g., left) to toggle between different graphical user interfaces or subcomponents (e.g., toggling between different languages or toggling between different character sets, etc.).

Additionally, in another example, a user may spin an input finger, such as the thumb 111, in one direction (e.g., clockwise) on the touchpad to extend a total capturing time while performing a recording operation (e.g., recording video or gameplay, etc.). Thus, in response to such input, an indicator of remaining recording time may increase. Additionally, the user may spin the input finger in an opposite direction (e.g., counterclockwise) to effectuate a countdown procedure such that, at the end of the countdown, recording will begin. Thus, performing a first instance of the spinning input may trigger a display indicating a countdown procedure. Spinning in this direction may be performed again to add more time to the countdown procedure. Moreover, in this example, the user may tap with the input finger to initiate recording at the time of tapping.

In yet another example, the user may optionally rotate the thumb/wrist such that the thumb/wrist is brought closer to the user, thereby navigating at a slower speed in a corresponding direction. The user may also optionally flick or swipe the touchpad in a parallel direction to navigate at a proportionally faster speed, for example. The user may also tap the touchpad to enable dragging of one of the items in the list.

In another example, the user may press and hold on the touchpad to select a displayed item. Similarly, the user may move the input finger around in a given shape, such as a circle, on the touchpad in order to change a currently selected or highlighted item or direction. For example, as the user rotates the input finger along the touchpad in one direction, such as clockwise, a displayed item within a graphical user interface may rotate accordingly.

Moreover, in some examples, an input finger such as the thumb 111 may hold or hover over a particular edge of the touchpad. In this illustrative example, the user may hold a left edge, the top edge, the bottom edge, or the right edge. Moreover, while holding or hovering over a corresponding edge, the user may rotate the haptic ring along an axis corresponding to the forearm such that the haptic ring rolls downward and to the left or downward and to the right, as one example. In other examples, the haptic ring may be rotated along a different axis or any suitable axis (e.g., any suitable one of yaw, pitch, and roll). Moreover, any one of the touchpad edges and/or axes may be mapped to one or more suitable parameters for adjustment. In the context of a digital camera, the parameters may include one or more of zoom (coarse or fine zoom), brightness, and/or one or more filters. Furthermore, as the user performs the rolling or twisting action, the haptic feedback unit may provide haptic feedback indicating or corresponding to the user toggling increasing or decreasing gradients along a scale corresponding to the selected parameter. Additionally, or alternatively, a graphical user interface may also provide a corresponding visual indication to match or parallel the haptic feedback.

In another example, the user may swipe along the touchpad of the haptic ring, or otherwise drag an input finger along the touchpad, to move a displayed cursor along a corresponding software implemented keyboard within a display. In this example, an audio and/or haptic feedback unit may provide feedback that is proportional to a speed of moving the input finger (e.g., higher pitch or stronger haptic feedback proportional to faster swiping speeds). The user may also optionally twist the haptic ring along one or more axes, as discussed above, up to a predetermined threshold, which may trigger the selection or toggling of the corresponding character within the software implemented keyboard.

Moreover, in a knob embodiment, the user may twist the haptic ring clockwise or counterclockwise by rotating the forearm and or wrist. For example, the user may rotate the forearm along an axis corresponding to the forearm. This twisting may cause the haptic ring to further toggle incremental increasing or decreasing of a parameter, which may be visually or otherwise represented as a software implemented knob. The user may have twisted the haptic ring clockwise along the axis corresponding to the forearm which may increase a value such as a speaker volume level. Similarly, if the user twists the haptic ring counterclockwise along the same axis, the speaker volume level may decrease to a lower value in proportion to the amount of twisting.

In a further knob embodiment, two software implemented knobs may be displayed within a graphical user interface. In this embodiment, the haptic ring may be configured or designed to effectively distinguish between the two of them, such as by using a magnetometer to detect which knob is more closely adjacent to the haptic ring or a direction in which the haptic ring is pointing. Upon pointing toward, or disposing the haptic ring adjacent to, one of the two software implemented knobs, the user may proceed to twist clockwise or counterclockwise along the axis of the forearm, as further discussed above, to incrementally increase or decrease a value along which the knob is measuring.

In some examples, the haptic ring can associate granularity of movement with different types of user motions. For example, the user may swipe the input finger along the touchpad in one or more directions, which may trigger or implement a finer grain of cursor movement between items in a corresponding set, panel, or page. In contrast, the user may rotate the haptic ring along an axis corresponding to the forearm to thereby trigger a coarser grain movement between different sets, panels, or pages themselves. Thus, by twisting the haptic ring clockwise along the axis corresponding to the forearm, the cursor may jump from one set to another while the cursor may move between items in a single set in response to swipes along the touchpad.

In any of the examples discussed above, the user's hand and wrist may remain substantially static or stationary (e.g., near the pocket of the user's pants). Nevertheless, despite the relative restriction of the user's hand and wrist, the haptic ring may enable substantial and comprehensive navigation and selection functionality across a range of different applications and menus or screens within various applications. One or more of these various input mechanisms may be mapped to different instances of functionality such as navigating forward or backward, selection, zooming in or out, increasing or decreasing a particular value of the parameter or measurement along a knob, list, panel, or page, etc.

FIG. 4 illustrates an example overview of a system 400 including a haptic ring 402 (e.g., such as the haptic ring 102, 202, or 302) in communication with another computing device 404. In one or more implementations, the computing device 404 may be a wearable computing device (e.g., such as an AR or VR head-mounted unit), a smart phone, a tablet computer, a laptop computer, or similar. In one or more implementations, the haptic ring 402 may include an inertial measurement unit (IMU) 406, an SOC 410 (e.g., a system on a chip including a CPU, input/output ports, memory, etc.), and optionally a button 408 (e.g., such as the pressure sensing touchpad 306 shown in FIG. 3).

In one or more implementations, the haptic ring 402 can transmit data (e.g., such as samples 412 from the IMU 406 and optionally from the button 408 to the computing device 404. In at least one implementation, the computing device 404 includes a haptic ring software development kit (SDK) 414 that includes one or more algorithms 416 for processing the samples 412. Additionally, the computing device 404 may include an application 418 that utilizes the data generated by the SDK 414. In this way, the interaction signals from the haptic ring 402 operate to move a displayed cursor, select a displayed object, switch to a new display, or perform any other I/O functionality in connection with the application 418.

In summary, the implementations described herein include a haptic ring that enables a user to interact with a computer display with minute gestures such as wrist and finger movements. Moreover, the haptic ring further includes a haptic feedback unit that can provide feedback to the user to indicate when an item is selected, a knob is turned, etc. In at least one implementation, the haptic ring includes a touchpad that is seamlessly incorporated into the ring unit such that the touchpad is indistinguishable from the rest of the ring. In this way, the haptic ring may be effectively camouflaged such that it appears like a normal ring even though it operates as a haptic-enabled I/O device.

### EXAMPLE IMPLEMENTATIONS

Example 1: An apparatus including a ring designed to curve around a human finger of a wearer, a touchpad integrated with the ring and operable by another finger of the wearer, and a haptic feedback unit integrated with the apparatus and designed to provide haptic feedback in response to input from the wearer, wherein the touchpad curves in a manner that substantially follows the curving of the ring around the human finger.

Example 2: The apparatus of Example 1, wherein the touchpad is seamlessly integrated with the ring to present a smooth and unified surface to another finger of the wearer.

Example 3: The apparatus of Examples 1 and 2, wherein the touchpad is implemented on a flexible printed circuit board such that the flexible printed circuit board flexes around the curving of the ring.

Example 4: The apparatus of any of Examples 1-3, wherein the flexible printed circuit board is disposed on material that bends, folds, and creases.

Example 5: The apparatus of any of Examples 1-4, wherein the haptic feedback unit is disposed beneath the flexible printed circuit board.

Example 6: The apparatus of any of Examples 1-5, wherein a driver or an inertial measurement unit is further disposed beneath the flexible printed circuit board.

Example 7: The apparatus of any of Examples 1-6, wherein the flexible printed circuit board is two-sided or four-sided.

Example 8: The apparatus of any of Examples 1-7, further including a magnetometer.

Example 9: The apparatus of any of Examples 1-8, further including a shield that is designed to shield the magnetometer from reading an item of data.

Example 10: The apparatus of any of Examples 1-9, wherein the touchpad corresponds to a two-dimensional surface that curves along a first dimension but substantially does not curve along a second dimension, and the apparatus is configured to recognize input along the second dimension as input along a horizontal dimension.

Example 11: A method for integrating a touchpad with a wearable ring including integrating a ring designed to curve around a human finger of a wearer with a touchpad operable by another finger of the wearer, integrating a haptic feedback unit with the ring, wherein the haptic feedback unit is designed to provide haptic feedback in response to input from the wearer, and the touchpad curves in a manner that substantially follows the curving of the ring around the human finger.

Example 12: The method of Example 11, wherein the touchpad is seamlessly integrated with the ring to present a smooth and unified surface to another finger of the wearer.

Example 13: The method of Examples 11 and 12, wherein the touchpad is implemented on a flexible printed circuit board such that the flexible printed circuit board flexes around the curving of the ring.

Example 14: The method of any of Examples 11-13, wherein the flexible printed circuit board is disposed on a material that bends, folds, and creases.

Example 15: The method of any of Examples 11-14, wherein the haptic feedback unit is disposed beneath the flexible printed circuit board.

Example 16: The method of any of Examples 11-15, wherein a driver or an inertial measurement unit is further disposed beneath the flexible printed circuit board.

Example 17: The method of any of Examples 11-16, wherein the flexible printed circuit board is two-sided or four-sided.

Example 18: The method of any of Examples 11-17, wherein the ring further includes a magnetometer.

Example 19: The method of any of Examples 11-18, wherein the ring further includes a shield that is designed to shield the magnetometer from reading an item of data.

Example 20: A method for providing haptic feedback through a wearable ring including receiving input from a wearer of a ring that curves around a human finger of the wearer, and providing, through a haptic feedback unit embedded in the ring, haptic feedback that is responsive to the input from the wearer, wherein the ring including a touchpad integrated with the ring and operable by another finger of the wearer, and the touchpad curves in a manner that substantially follows the curving of the ring around the human finger.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 500 in FIG. 5) or that visually immerses a user in an artificial reality (such as, e.g., virtual-reality system 600 in FIG. 6). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 5, augmented-reality system 500 may include an eyewear device 502 with a frame 510 configured to hold a left display device 515(A) and a right display device 515(B) in front of a user's eyes. Display devices 515(A) and 515(B) may act together or independently to present an image or series of images to a user. While augmented-reality system 500 includes two displays, embodiments of this disclosure may be implemented in augmented-reality systems with a single NED or more than two NEDs.

In some embodiments, augmented-reality system 500 may include one or more sensors, such as sensor 540. Sensor 540 may generate measurement signals in response to motion of augmented-reality system 500 and may be located on substantially any portion of frame 510. Sensor 540 may represent one or more of a variety of different sensing mechanisms, such as a position sensor, an inertial measurement unit (IMU), a depth camera assembly, a structured light emitter and/or detector, or any combination thereof. In some embodiments, augmented-reality system 500 may or may not include sensor 540 or may include more than one sensor. In embodiments in which sensor 540 includes an IMU, the IMU may generate calibration data based on measurement signals from sensor 540. Examples of sensor 540 may include, without limitation, accelerometers, gyroscopes, magnetometers, other suitable types of sensors that detect motion, sensors used for error correction of the IMU, or some combination thereof.

In some examples, augmented-reality system 500 may also include a microphone array with a plurality of acoustic transducers 520(A)-520(J), referred to collectively as acoustic transducers 520. Acoustic transducers 520 may represent transducers that detect air pressure variations induced by sound waves. Each acoustic transducer 520 may be configured to detect sound and convert the detected sound into an electronic format (e.g., an analog or digital format). The microphone array in FIG. 5 may include, for example, ten acoustic transducers: 520(A) and 520(B), which may be designed to be placed inside a corresponding ear of the user, acoustic transducers 520(C), 520(D), 520(E), 520(F), 520(G), and 520(H), which may be positioned at various locations on frame 510, and/or acoustic transducers 520(1) and 520(J), which may be positioned on a corresponding neckband 505.

In some embodiments, one or more of acoustic transducers 520(A)-(J) may be used as output transducers (e.g., speakers). For example, acoustic transducers 520(A) and/or 520(B) may be earbuds or any other suitable type of headphone or speaker.

The configuration of acoustic transducers 520 of the microphone array may vary. While augmented-reality system 500 is shown in FIG. 5 as having ten acoustic transducers 520, the number of acoustic transducers 520 may be greater or less than ten. In some embodiments, using higher numbers of acoustic transducers 520 may increase the amount of audio information collected and/or the sensitivity and accuracy of the audio information. In contrast, using a lower number of acoustic transducers 520 may decrease the computing power required by an associated controller 550 to process the collected audio information. In addition, the position of each acoustic transducer 520 of the microphone array may vary. For example, the position of an acoustic transducer 520 may include a defined position on the user, a defined coordinate on frame 510, an orientation associated with each acoustic transducer 520, or some combination thereof.

Acoustic transducers 520(A) and 520(B) may be positioned on different parts of the user's ear, such as behind the pinna, behind the tragus, and/or within the auricle or fossa. Or there may be additional acoustic transducers 520 on or surrounding the ear in addition to acoustic transducers 520 inside the ear canal. Having an acoustic transducer 520 positioned next to an ear canal of a user may enable the microphone array to collect information on how sounds arrive at the ear canal. By positioning at least two of acoustic transducers 520 on either side of a user's head (e.g., as binaural microphones), augmented-reality device 500 may simulate binaural hearing and capture a 3D stereo sound field around about a user's head. In some embodiments, acoustic transducers 520(A) and 520(B) may be connected to augmented-reality system 500 via a wired connection 530, and in other embodiments acoustic transducers 520(A) and 520(B) may be connected to augmented-reality system 500 via a wireless connection (e.g., a BLUETOOTH connection). In still other embodiments, acoustic transducers 520(A) and 520(B) may not be used at all in conjunction with augmented-reality system 500.

Acoustic transducers 520 on frame 510 may be positioned in a variety of different ways, including along the length of the temples, across the bridge, above or below display devices 515(A) and 515(B), or some combination thereof. Acoustic transducers 520 may also be oriented such that the microphone array is able to detect sounds in a wide range of directions surrounding the user wearing the augmented-reality system 500. In some embodiments, an optimization process may be performed during manufacturing of augmented-reality system 500 to determine relative positioning of each acoustic transducer 520 in the microphone array.

In some examples, augmented-reality system 500 may include or be connected to an external device (e.g., a paired device), such as neckband 505. Neckband 505 generally represents any type or form of paired device. Thus, the following discussion of neckband 505 may also apply to various other paired devices, such as charging cases, smart watches, smart phones, wrist bands, other wearable devices, hand-held controllers, tablet computers, laptop computers, other external compute devices, etc.

As shown, neckband 505 may be coupled to eyewear device 502 via one or more connectors. The connectors may be wired or wireless and may include electrical and/or non-electrical (e.g., structural) components. In some cases, eyewear device 502 and neckband 505 may operate independently without any wired or wireless connection between them. While FIG. 5 illustrates the components of eyewear device 502 and neckband 505 in example locations on eyewear device 502 and neckband 505, the components may be located elsewhere and/or distributed differently on eyewear device 502 and/or neckband 505. In some embodiments, the components of eyewear device 502 and neckband 505 may be located on one or more additional peripheral devices paired with eyewear device 502, neckband 505, or some combination thereof.

Pairing external devices, such as neckband 505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 500 may be provided by a paired device or shared between a paired device and an eyewear device, thus reducing the weight, heat profile, and form factor of the eyewear device overall while still retaining desired functionality. For example, neckband 505 may allow components that would otherwise be included on an eyewear device to be included in neckband 505 since users may tolerate a heavier weight load on their shoulders than they would tolerate on their heads. Neckband 505 may also have a larger surface area over which to diffuse and disperse heat to the ambient environment. Thus, neckband 505 may allow for greater battery and computation capacity than might otherwise have been possible on a stand-alone eyewear device. Since weight carried in neckband 505 may be less invasive to a user than weight carried in eyewear device 502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 505 may be communicatively coupled with eyewear device 502 and/or to other devices. These other devices may provide certain functions (e.g., tracking, localizing, depth mapping, processing, storage, etc.) to augmented-reality system 500. In the embodiment of FIG. 5, neckband 505 may include two acoustic transducers (e.g., 520(1) and 520(J)) that are part of the microphone array (or potentially form their own microphone subarray). Neckband 505 may also include a controller 525 and a power source 535.

Acoustic transducers 520(1) and 520(J) of neckband 505 may be configured to detect sound and convert the detected sound into an electronic format (analog or digital). In the embodiment of FIG. 5, acoustic transducers 520(1) and 520(J) may be positioned on neckband 505, thereby increasing the distance between the neckband acoustic transducers 520(1) and 520(J) and other acoustic transducers 520 positioned on eyewear device 502. In some cases, increasing the distance between acoustic transducers 520 of the microphone array may improve the accuracy of beamforming performed via the microphone array. For example, if a sound is detected by acoustic transducers 520(C) and 520(D) and the distance between acoustic transducers 520(C) and 520(D) is greater than, e.g., the distance between acoustic transducers 520(D) and 520(E), the determined source location of the detected sound may be more accurate than if the sound had been detected by acoustic transducers 520(D) and 520(E).

Controller 525 of neckband 505 may process information generated by the sensors on neckband 505 and/or augmented-reality system 500. For example, controller 525 may process information from the microphone array that describes sounds detected by the microphone array. For each detected sound, controller 525 may perform a direction-of-arrival (DOA) estimation to estimate a direction from which the detected sound arrived at the microphone array. As the microphone array detects sounds, controller 525 may populate an audio data set with the information. In embodiments in which augmented-reality system 500 includes an inertial measurement unit, controller 525 may compute all inertial and spatial calculations from the IMU located on eyewear device 502. A connector may convey information between augmented-reality system 500 and neckband 505 and between augmented-reality system 500 and controller 525. The information may be in the form of optical data, electrical data, wireless data, or any other transmittable data form. Moving the processing of information generated by augmented-reality system 500 to neckband 505 may reduce weight and heat in eyewear device 502, making it more comfortable to the user.

Power source 535 in neckband 505 may provide power to eyewear device 502 and/or to neckband 505. Power source 535 may include, without limitation, lithium ion batteries, lithium-polymer batteries, primary lithium batteries, alkaline batteries, or any other form of power storage. In some cases, power source 535 may be a wired power source. Including power source 535 on neckband 505 instead of on eyewear device 502 may help better distribute the weight and heat generated by power source 535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 600 in FIG. 6, that mostly or completely covers a user's field of view. Virtual-reality system 600 may include a front rigid body 602 and a band 604 shaped to fit around a user's head. Virtual-reality system 600 may also include output audio transducers 606(A) and 606(B). Furthermore, while not shown in FIG. 6, front rigid body 602 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 500 and/or virtual-reality system 600 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 500 and/or virtual-reality system 600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 500 and/or virtual-reality system 600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within this disclosure.

As noted, artificial-reality systems 500 and 600 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 7 illustrates a vibrotactile system 700 in the form of a wearable glove (haptic device 710) and wristband (haptic device 720). Haptic device 710 and haptic device 720 are shown as examples of wearable devices that include a flexible, wearable textile material 730 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 740 may be positioned at least partially within one or more corresponding pockets formed in textile material 730 of vibrotactile system 700. Vibrotactile devices 740 may be positioned in locations to provide a vibrating sensation (e.g., haptic feedback) to a user of vibrotactile system 700. For example, vibrotactile devices 740 may be positioned against the user's finger(s), thumb, or wrist, as shown in FIG. 7. Vibrotactile devices 740 may, in some examples, be sufficiently flexible to conform to or bend with the user's corresponding body part(s).

A power source 750 (e.g., a battery) for applying a voltage to the vibrotactile devices 740 for activation thereof may be electrically coupled to vibrotactile devices 740, such as via conductive wiring 752. In some examples, each of vibrotactile devices 740 may be independently electrically coupled to power source 750 for individual activation. In some embodiments, a processor 760 may be operatively coupled to power source 750 and configured (e.g., programmed) to control activation of vibrotactile devices 740.

Vibrotactile system 700 may be implemented in a variety of ways. In some examples, vibrotactile system 700 may be a standalone system with integral subsystems and components for operation independent of other devices and systems. As another example, vibrotactile system 700 may be configured for interaction with another device or system 770. For example, vibrotactile system 700 may, in some examples, include a communications interface 780 for receiving and/or sending signals to the other device or system 770. The other device or system 770 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 780 may enable communications between vibrotactile system 700 and the other device or system 770 via a wireless (e.g., Wi-Fi, BLUETOOTH, cellular, radio, etc.) link or a wired link. If present, communications interface 780 may be in communication with processor 760, such as to provide a signal to processor 760 to activate or deactivate one or more of the vibrotactile devices 740.

Vibrotactile system 700 may optionally include other subsystems and components, such as touch-sensitive pads 790, pressure sensors, motion sensors, position sensors, lighting elements, and/or user interface elements (e.g., an on/off button, a vibration control element, etc.). During use, vibrotactile devices 740 may be configured to be activated for a variety of different reasons, such as in response to the user's interaction with user interface elements, a signal from the motion or position sensors, a signal from the touch-sensitive pads 790, a signal from the pressure sensors, a signal from the other device or system 770, etc.

Although power source 750, processor 760, and communications interface 780 are illustrated in FIG. 7 as being positioned in haptic device 720, the present disclosure is not so limited. For example, one or more of power source 750, processor 760, or communications interface 780 may be positioned within haptic device 710 or within another wearable textile.

Haptic wearables, such as those shown in and described in connection with FIG. 7, may be implemented in a variety of types of artificial-reality systems and environments. FIG. 8 shows an example artificial-reality environment 800 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 802 generally represents any type or form of virtual-reality system, such as virtual-reality system 600 in FIG. 6. Haptic device 804 generally represents any type or form of wearable device, worn by a user of an artificial-reality system, that provides haptic feedback to the user to give the user the perception that he or she is physically engaging with a virtual object. In some embodiments, haptic device 804 may provide haptic feedback by applying vibration, motion, and/or force to the user. For example, haptic device 804 may limit or augment a user's movement. To give a specific example, haptic device 804 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 804 to send action requests to a console. Examples of action requests include, without limitation, requests to start an application and/or end the application and/or requests to perform a particular action within the application.

While haptic interfaces may be used with virtual-reality systems, as shown in FIG. 8, haptic interfaces may also be used with augmented-reality systems, as shown in FIG. 9. FIG. 9 is a perspective view of a user 910 interacting with an augmented-reality system 900. In this example, user 910 may wear a pair of augmented-reality glasses 920 that may have one or more displays 922 and that are paired with a haptic device 930. In this example, haptic device 930 may be a wristband that includes a plurality of band elements 932 and a tensioning mechanism 934 that connects band elements 932 to one another.

One or more of band elements 932 may include any type or form of actuator suitable for providing haptic feedback. For example, one or more of band elements 932 may be configured to provide one or more of various types of cutaneous feedback, including vibration, force, traction, texture, and/or temperature. To provide such feedback, band elements 932 may include one or more of various types of actuators. In one example, each of band elements 932 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 710, 720, 804, and 930 may include any suitable number and/or type of haptic transducer, sensor, and/or feedback mechanism. For example, haptic devices 710, 720, 804, and 930 may include one or more mechanical transducers, piezoelectric transducers, and/or fluidic transducers. Haptic devices 710, 720, 804, and 930 may also include various combinations of different types and forms of transducers that work together or independently to enhance a user's artificial-reality experience. In one example, each of band elements 932 of haptic device 930 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
a ring designed to curve around a human finger of a wearer;
a touchpad integrated with the ring and operable by another finger of the wearer; and
a haptic feedback unit integrated with the apparatus and designed to provide haptic feedback in response to input from the wearer;
wherein:
the touchpad curves in a manner that substantially follows the curving of the ring around the human finger.

2. The apparatus of claim 1, wherein the touchpad is seamlessly integrated with the ring to present a smooth and unified surface to another finger of the wearer.

3. The apparatus of claim 1, wherein the touchpad is implemented on a flexible printed circuit board such that the flexible printed circuit board flexes around the curving of the ring.

4. The apparatus of claim 3, wherein the flexible printed circuit board is disposed on a material that bends, folds, and creases.

5. The apparatus of claim 3, wherein the haptic feedback unit is disposed beneath the flexible printed circuit board.

6. The apparatus of claim 5, wherein a driver or an inertial measurement unit is further disposed beneath the flexible printed circuit board.

7. The apparatus of claim 3, wherein the flexible printed circuit board is two-sided or four-sided.

8. The apparatus of claim 1, further comprising a magnetometer.

9. The apparatus of claim 8, further comprising a shield that is designed to shield the magnetometer from reading an item of data.

10. The apparatus of claim 1, wherein:
the touchpad corresponds to a two-dimensional surface that curves along a first dimension but substantially does not curve along a second dimension; and
the apparatus is configured to recognize input along the second dimension as input along a horizontal dimension.

11. A method comprising:
integrating a ring designed to curve around a human finger of a wearer with a touchpad operable by another finger of the wearer; and
integrating a haptic feedback unit with the ring;
wherein:
the haptic feedback unit is designed to provide haptic feedback in response to input from the wearer; and
the touchpad curves in a manner that substantially follows the curving of the ring around the human finger.

12. The method of claim 11, wherein the touchpad is seamlessly integrated with the ring to present a smooth and unified surface to another finger of the wearer.

13. The method of claim 11, wherein the touchpad is implemented on a flexible printed circuit board such that the flexible printed circuit board flexes around the curving of the ring.

14. The method of claim 13, wherein the flexible printed circuit board is disposed on a material that bends, folds, and creases.

15. The method of claim 13, wherein the haptic feedback unit is disposed beneath the flexible printed circuit board.

16. The method of claim 15, wherein a driver or an inertial measurement unit is further disposed beneath the flexible printed circuit board.

17. The method of claim 13, wherein the flexible printed circuit board is two-sided or four-sided.

18. The method of claim 11, wherein the ring further comprises a magnetometer.

19. The method of claim 18, wherein the ring further comprises a shield that is designed to shield the magnetometer from reading an item of data.

20. A method comprising:
receiving input from a wearer of a ring that curves around a human finger of the wearer; and
providing, through a haptic feedback unit embedded in the ring, haptic feedback that is responsive to the input from the wearer;
wherein:
the ring comprises a touchpad integrated with the ring and operable by another finger of the wearer; and
the touchpad curves in a manner that substantially follows the curving of the ring around the human finger.
